(19) United States
(12) Patent Application Publication
(10) Pub. No.: US 2010/0147080 A1
(43) Pub. Date: Jun. 17, 2010

(54) ULTRASONIC TRANSDUCER

(75) Inventors: Edward James Nieters, Burnt Hills, NY (US); Michael Francis Xavier Gigliotti, JR., Scotia, NY (US); James Norman Barshinger, Scotia, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/335,621

(22) Filed: Dec. 16, 2008

(51) Int. Cl. G01N 29/032

(52) U.S. Cl. 73/600

(57) ABSTRACT

An ultrasonic transducer comprises a transmitting element for transmitting an ultrasonic signal at a fundamental frequency and a receiving element adaptable for multiple receive water path operations and for receiving ultrasonic signals at the fundamental frequency and harmonics of the fundamental frequency.

### BACKGROUND

The subject matter disclosed herein relates generally to ultrasonic transducers and, more particularly, to an improved ultrasonic transducer that is capable of receiving signals over a broad range of frequencies with independent and variable control over the transmit and receive water paths.

Ultrasonic non-destructive testing uses high frequency sound waves to interrogate the quality or integrity of materials or components such as, for example, detection of flaws such as cracks, corrosion or delaminations, dimensional measurements, and material characterizations. A fundamental component of an ultrasonic testing system is the ultrasonic transducer that converts electrical energy to ultrasonic energy and inversely, ultrasonic energy to electrical energy. In a typical inspection scenario, the ultrasonic energy generated by the transducer propagates through the tested material in the form of waves. A portion of the transmitted ultrasonic wave gets reflected when there is a defect, such as a discontinuity, or any irregularity in the path of ultrasonic waves. The reflected waves are received by the transducer and converted to electrical signals. The electrical signals are then analyzed for information regarding defects.

Typical ultrasonic transducers are resonant devices and are often constructed using piezoelectric elements with a thickness of one half the wavelength at some desired frequency. The transmit/receive frequency spectrum of such transducers can be described as a damped resonance which, when excited with a broadband pulse, has a peak at the resonant frequency and also has frequency components below and above this resonant frequency. The frequency response is usually described in terms of fractional bandwidth, BW=(f1−f2)/fc, where f1 and f2 are the −6 dB upper and lower band edges, respectively, and fc is the center frequency. Typical transducers have a fractional bandwidth in the range of 40% to 100%. Because of the nature of an ultrasonic transducer being constructed from a ½ wavelength resonant element, the frequency response will also have some components around the odd integer multiples of the center frequency. These integer multiples of the resonant frequency are called harmonics.

The functional relationship between stress and strain in materials involves a linear component (Hooke's Law) and also higher order (nonlinear) terms. When a material is excited at a frequency, the response includes that frequency plus harmonic components. Changes in the amplitude of the harmonic frequencies can be used to characterize material state. This method is known as nonlinear ultrasound.

In nonlinear ultrasound, the transducer is excited with a narrowband pulse at the fundamental (center) frequency of the transducer and the fundamental and one or more harmonic frequency amplitudes are recorded. Analysis using the ratios of these components can be used to identify material damage at an earlier stage of life compared to conventional, broadband ultrasonic testing which only evaluates the energy of the fundamental frequency.

Using a standard transducer as the excitation source in nonlinear ultrasound will generate its fundamental resonant frequency along with components at odd integer multiples as described above. Since the nonlinear ultrasound technique depends on evaluating the harmonics generated by the material as opposed to those generated in the transducer, it is advantageous to monitor and record the 2nd (or other even) harmonic amplitude(s) since these will, by definition, not come from the transducer. However, the transmitting transducer is also not capable of receiving these even harmonics so it becomes necessary to use a second transducer centered on the 2^{nd} harmonic frequency as a receiver. Furthermore, if a non-resonant receiver is used, both the fundamental and higher order harmonics could be received with a single device.

In immersion testing, where an intermediate medium such as water is used to couple the ultrasound into the material or component under test, a further complication arises because the fluid is a significant source of harmonic generation. These parasitic harmonics, which do not come from the material itself, should be minimized. Shortening the water path will reduce the amount of water that can generate harmonics and is one way to decrease these unwanted signals.

Since a single ultrasonic transducer is not be capable of receiving the even harmonic frequencies and is physically constrained to a single water path for both transmit and receive operations, it would be desirable to provide an ultrasonic transducer capable of transmitting a fundamental frequency, receiving fundamental and even harmonic frequencies, and is adaptable for multiple receive water paths.

### BRIEF DESCRIPTION

In accordance with one embodiment disclosed herein, an ultrasonic transducer comprises a transmitting element for transmitting an ultrasonic wave at a fundamental frequency and a receiving element adaptable for multiple receive water path operations and for receiving ultrasonic signals at the fundamental frequency and harmonics of the fundamental frequency.

In accordance with another embodiment disclosed herein, an ultrasonic transducer comprises a transmitting element for transmitting an ultrasonic signal at a fundamental frequency and a receiving element for receiving ultrasonic signals at the fundamental frequency and harmonics of the fundamental frequency. The receiving element is movable and securable at various positions with respect to the transmitting element to adapt for multiple receive water paths.

In accordance with another embodiment disclosed herein, an ultrasonic transducer comprises a transmitting element for transmitting an ultrasonic signal at a fundamental frequency and a receiving element comprising a broadband hydrophone (non-resonant) for receiving ultrasonic signals at the fundamental frequency and harmonics of the fundamental frequency. The receiving element is movable and securable at various positions with respect to the transmitting element to adapt for multiple receive water paths.

In accordance with another embodiment disclosed herein, an ultrasonic transducer comprises a transmitting element for transmitting an ultrasonic signal at a fundamental frequency and receiving ultrasonic signals at the fundamental frequency; and a receiving element adaptable for multiple receive water path operations and for receiving harmonics of the fundamental frequency.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an immersion-based ultrasonic testing procedure using an ultrasonic transducer.

FIG. 2 illustrates an embodiment of the ultrasonic transducer in accordance with aspects disclosed herein.

FIG. 3 illustrates a top view of the ultrasonic transducer of FIG. 2 in accordance with aspects disclosed herein.

FIG. 4 illustrates another embodiment of the ultrasonic transducer in accordance with aspects disclosed herein.

### DETAILED DESCRIPTION

Embodiments disclosed herein include an ultrasonic transducer. The ultrasonic transducer includes a transmitting element for transmitting an ultrasonic signal at a fundamental frequency and a receiving element for receiving ultrasonic signals at the fundamental frequency and harmonics of the fundamental frequency. The receiving element is adaptable for multiple receive water path operations. As used herein, singular forms such as “a,” “an,” and “the” include plural referents unless the context clearly dictates otherwise.

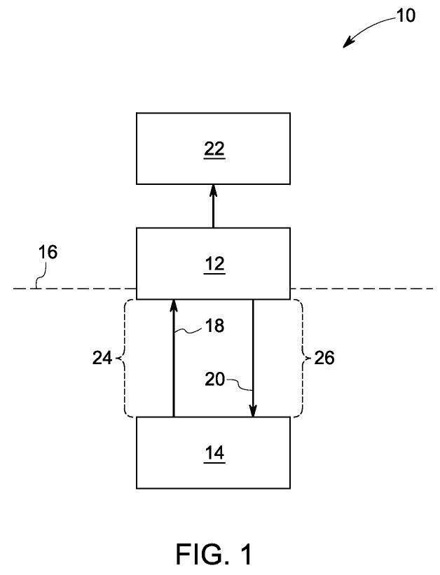

FIG. 1 illustrates an immersion-based ultrasonic testing 10 procedure using an ultrasonic transducer. Immersion-based ultrasonic testing is conducted in a fluid medium such as water. The ultrasonic transducer 12 and a work piece 14 to be tested or inspected are immersed in water 16. The ultrasonic transducer 12 transmits ultrasonic signals 18 at a frequency that is generally referred to as a fundamental frequency. The ultrasonic signals 18 at fundamental frequency penetrate the work piece 14. The ultrasonic signals 18 are reflected when encountered by a defect such as a discontinuity or any irregularity. The reflected ultrasonic signals 20 include signals at the fundamental frequency and harmonics of the fundamental frequency. The ultrasonic transducer 12 captures the reflected ultrasonic signals 20. A processing unit 22 then analyzes the reflected signals 20 for information regarding defects.

Water path is one of the parameters in immersion-based ultrasonic testing procedure. A water path can be defined as the distance between the ultrasonic transducer and the surface of the work piece. A water path can be divided into two components, namely, a transmit water path and a receive water path in the case of a dual-element ultrasonic transducer. The distance between the transmit element and the surface of the work piece is called a transmit water path 24. The distance between the receive element and the surface of the work piece is called a receive water path 26. In a typical immersion-based ultrasonic transducer, the transmit water path 24 and the receive water path 26 are equal.

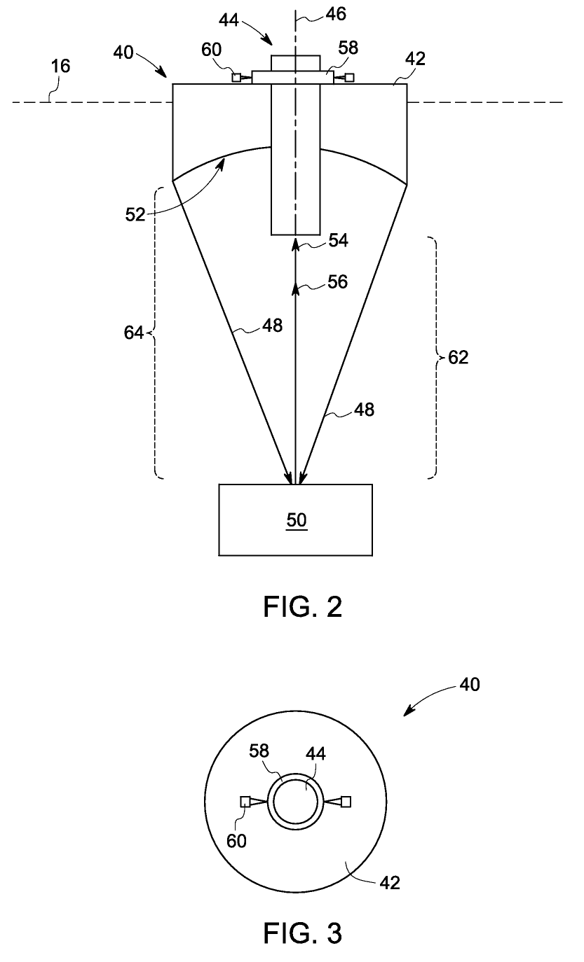

FIGS. 2 and 3 illustrate one embodiment of an ultrasonic transducer 40. The ultrasonic transducer 40 is used for immersion-based ultrasonic testing. The ultrasonic transducer includes a transmitting element 42 and a receiving element 44 at the center of the transmitting element 42. The receiving element 44 is co-axial with the transmitting element 42 and is movable along a central axis 46 of the transducer 40.

The transmitting element 42 transmits ultrasonic signals 48 towards a work piece 50. The frequency at which the ultrasonic signals 48 are transmitted from the transmitting element 42 is referred to as a fundamental frequency. In one embodiment, the transmitting element 42 includes a typical ultrasonic transducer material such as a piezo-electric material. The transmitting element 42 includes a focusing feature 52 to focus ultrasonic signals 48 onto a specific location on the work piece 50. In one embodiment, the focusing feature 52 includes a curved profile to focus the transmitted ultrasonic signals along a line (cylindrical focus). In another embodiment (not shown), the focusing feature includes a curved profile to make the ultrasonic signals converge at a point (spherical focus).

In one embodiment as in FIG. 2, the receiving element 44 is a broadband, non-resonant device designed to receive ultrasonic signals over a range of frequencies that include the fundamental and the harmonics of the transmitter. The ultrasonic signals 48 are reflected when they encounter a defect such as a discontinuity or any irregularity in the work piece 50. The reflected ultrasonic signals include signals at the fundamental frequency 54 and harmonics 56 of the fundamental frequency. In this embodiment, the receiving element 44 is dedicated to receive both fundamental and harmonic frequency ultrasonic signals. The receiving element 44 can be small to allow for minimal interference with the transmitted ultrasonic signals and to eliminate any directionality requirements, such as receive focus, to adequately acquire the reflected signals.

The receiving element 44 is movable and securable at various positions with respect to the transmitting element 42 to adapt for multiple receive water paths. In one embodiment, the ultrasonic transducer includes a sleeve 58 and a screw 60. The receiving element 44 can be moved inside the sleeve 58 along the central axis 46 of the ultrasonic transducer. The sleeve 58 has holes (not shown) to accommodate the screws 60. The receiving element 44 can be secured at a position by tightening the screws 60.

The sleeve 58 and screw 60 mechanism enables the receiving element 44 to be secured at various positions along the central axis 46 to adapt for multiple receive water path operations. In the embodiment shown in FIG. 2, the receiving element 44 is secured at a position corresponding to a receive water path 62 that is different from a transmit water path 64. The receive water path 62 is shorter than the transmit water path 64. The receiving element 44 can also be secured at a position such that the transmit water path and the receive water path are same.

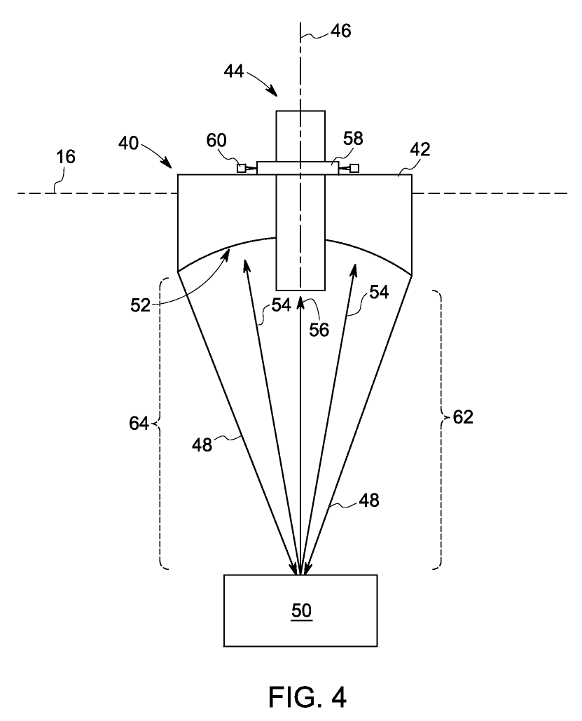

In another embodiment as shown in FIG. 4, the receiving element 44 is a narrowband, resonant device designed to receive ultrasonic signals specifically at the one of the harmonic frequencies of the transmitter. The ultrasonic signals 48 are reflected when they encounter a defect such as a discontinuity or any irregularity in the work piece 50. The reflected ultrasonic signals include signals at the fundamental frequency 54 and harmonics 56 of the fundamental frequency. In this embodiment, the receiving element 44 is dedicated to receive harmonic ultrasonic signals and the transmitting element 42 is dedicated to receive the fundamental frequency signal. The receiving element 44 can be small to allow for minimal interference with the transmitted ultrasonic signals and to eliminate any directionality requirements, such as receive focus, to adequately acquire the reflected signals.

In prior art applications, two physically separate ultrasonic transducers were used to receive ultrasonic signals at the fundamental frequency and harmonics of the fundamental frequency. A first transducer transmits ultrasonic signals at fundamental frequency. The transducers can be placed on either side of a work piece or inclined to focus on to a point on a work piece. But using two physically separate transducers is not always feasible, especially for work pieces having inaccessible geometries and hollow internal features such as cooling passages. The ultrasonic transducer 40 can receive ultrasonic signals at the fundamental frequency and harmonics of the fundamental frequency, coaxially and from a single side of the part, thereby eliminating the need for two transducers.

Ultrasonic signals can significantly attenuate over longer water paths. A receive water path shorter than a transmit water path allows for acquisition of low amplitude and higher frequency ultrasonic signal with better signal to noise ratio. With a shorter receive water path, ultrasonic signals reflected by a work piece need to travel shorter distance in water, leading to reduction in attenuation effects. Furthermore, a shorter receive water path minimizes the amount of received harmonics due to nonlinear ultrasound generation in the water.

The ultrasonic transducer 40 described above thus provides a way to have multiple receive water paths. The capability of receiving ultrasonic signals at the fundamental frequency and harmonics of the fundamental frequency permits single-sided inspection with easier access for hard-to-reach geometries. The broadband hydrophone has superior frequency response over a typical piezo-electric receiving element. The ultrasonic transducer permits to have a receive water path shorter than a transmit water path to acquire signals with minimal attenuation.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An ultrasonic transducer, comprising:
a transmitting element for transmitting an ultrasonic signal at a fundamental frequency; and
a receiving element adaptable for multiple receive water path operations and for receiving ultrasonic signals at the fundamental frequency and harmonics of the fundamental frequency.

2. The ultrasonic transducer of claim 1, wherein the receiving element is movable and securable at various positions with respect to the transmitting element to adapt for multiple receive water paths.

3. The ultrasonic transducer of claim 2, wherein the receiving element is positioned with respect to the transmitting element such that a transmit water path and the receive water path are same.

4. The ultrasonic transducer of claim 2, wherein the receiving element is positioned with respect to the transmitting element such that a transmit water path and the receive water path are different.

5. The ultrasonic transducer of claim 2, wherein the receiving element is movable along a central axis of the transducer.

6. The ultrasonic transducer of claim 2, wherein the receiving element comprises a broadband hydrophone.

7. The ultrasonic transducer of claim 2, wherein the receiving element is co-axial with the transmitting element.

8. The ultrasonic transducer of claim 1, wherein the transmitting element comprises a focusing feature to focus the ultrasonic signals.

9. An ultrasonic transducer, comprising:
a transmitting element for transmitting an ultrasonic signal at a fundamental frequency; and
a receiving element for receiving ultrasonic signals at the fundamental frequency and harmonics of the fundamental frequency, the receiving element is movable and securable at various positions with respect to the transmitting element to adapt for multiple receive water paths.

10. The ultrasonic transducer of claim 9, wherein the receiving element is positioned with respect to the transmitting element such that a transmit water path and the receive water path are same.

11. The ultrasonic transducer of claim 9, wherein the receiving element is positioned with respect to the transmitting element such that a transmit water path and the receive water path are different.

12. The ultrasonic transducer of claim 9, wherein the receiving element is movable along a central axis of the transducer.

13. The ultrasonic transducer of claim 9, wherein the receiving element comprises a broadband hydrophone.

14. The ultrasonic transducer of claim 9, wherein the receiving element is co-axial with the transmitting element.

15. The ultrasonic transducer of claim 9, wherein the transmitting element comprises a focusing feature to focus the ultrasonic signals.

16. An ultrasonic transducer, comprising:
a transmitting element for transmitting an ultrasonic signal at a fundamental frequency; and
a receiving element comprising a broadband hydrophone for receiving ultrasonic signals at the fundamental frequency and harmonics of the fundamental frequency, the receiving element is movable and securable at various positions with respect to the transmitting element to adapt for multiple receive water paths.

17. The ultrasonic transducer of claim 16, wherein the receiving element is positioned with respect to the transmitting element such that a transmit water path and the receive water path are same.

18. The ultrasonic transducer of claim 16, wherein the receiving element is positioned with respect to the transmitting element such that a transmit water path and the receive water path are different.

19. The ultrasonic transducer of claim 16, wherein the receiving element is movable along a central axis of the transducer.

20. The ultrasonic transducer of claim 16, wherein the receiving element is co-axial with the transmitting element.

21. The ultrasonic transducer of claim 16, wherein the transmitting element comprises a focusing feature to focus the ultrasonic signals.

22. An ultrasonic transducer, comprising:
a transmitting element for transmitting an ultrasonic signal at a fundamental frequency and receiving ultrasonic signals at the fundamental frequency; and
a receiving element adaptable for multiple receive water path operations and for receiving harmonics of the fundamental frequency.

23. The ultrasonic transducer of claim 22, wherein the receiving element is movable and securable at various positions with respect to the transmitting element to adapt for multiple receive water paths.

24. The ultrasonic transducer of claim 22, wherein the receiving element is movable along a central axis of the transducer.

25. The ultrasonic transducer of claim 22, wherein the transmitting element comprises a focusing feature.
